(19) United States
(12) Patent Application Publication
(10) Pub. No.: US 2014/0211658 A1
(43) Pub. Date: Jul. 31, 2014

(54) WIRELESS APPARATUS AND NETWORK ADDRESS REPORT METHOD IN ZIGBEE NETWORK

(71) Applicant: Yung Weng Fan, Singapore (SG)

(72) Inventor: Yung Weng Fan, Singapore (SG)

(73) Assignee: AAC TECHNOLOGIES PTE. LTD, Singapore (SG)

(21) Appl. No.: 14/159,863

(22) Filed: Jan. 21, 2014

(30) Foreign Application Priority Data
Jan. 25, 2013 (CN) 201310028756.2

(51) Int. Cl. H04L 29/12

(52) U.S. Cl. CPC H04L 61/2038
USPC 370/254

(57) ABSTRACT

A wireless apparatus in ZIGBEE network has a host controller, a ZIGBEE module communicated the host controller and including a RF transceiver for receiving or transmitting a signal, a ZIGBEE stack engine connected the RF transceiver, a decoder connected the ZIGBEE stack engine, a memory, a minor serial interface, and a serial command manger. The decoder decodes an address signal from the ZIGBEE stack engine and stores the address signal to the memory, and transmitting a signal to the host controller. The host controller sends an address request serial command according to the signal to the ZIGBEE module. According to the address request serial command, the serial command manager shifts the address signal from the memory to the minor serial interface and transmits the address signal to the host controller.

### RELATED PATENT APPLICATION

This application claims the priority benefit of Chinese Patent Application Filing Serial Number CN 201310028756.2, the disclosure of which is herein incorporated by reference in its entirety.

### FIELD OF THE INVENTION

The present disclosure relates to the art of ZIGBEE network and, particularly to a method and apparatus for assigning an internet protocol addresses to a client device to provide Internet Protocol (IP) service in a ZIGBEE network system.

### DESCRIPTION OF RELATED ART

The ZIGBEE communication scheme uses the IEEE 802.15.4 standard supporting short-range communication. ZIGBEE, as used herein, refers to a specification for a suite of communication protocols for a Wireless Personal Area Network (WPAN). The term “ZIGBEE communication scheme” refers to a technology for 10 to 20-meter short-range communication and ubiquitous computing in a wireless network environment such as home and office network environments. In particular, the ZIGBEE communication scheme, a low-power communication scheme, can minimize power consumption, so power consumption can be suitable for devices including mobile communication terminals.

Recently, communication schemes have been proposed that support Internet Protocol (IP) service using the ZIGBEE communication scheme. In the IP service, a communication terminal is assigned an IP address, and can transmit/receive data using the IP address. A ZIGBEE coordinator forming a ZIGBEE network can include several servers in the network and provide IP service to the communication terminals entering the ZIGBEE network.

Typically, due to wither the lack of engineering resources, expertise , or economy of scale , many of the ZIGBEE products manufactures suing integrated ZIGBEE transceiver module in their product instead of designing the RF circuitry directly in a main printed circuit boards. ZIGBEE transceiver module is a pre-design integrated solution with the chipset, antenna, RF and digital circuitry fabricated and tested on a small PCB. Manufactures solder or mount them directly to the main PCB. Manufactures usually use a host controller to interface and control a ZIGBEE module via a serial interface. The host controller is the master while the ZIGBEE module acts as a slave device which accepts commands and responses upon request from the host controller. The host controller sends a serial commands to the ZIGBEE module which the ZIGBEE module processes and executes. Upon completion, the ZIGBEE module sends the response and results back to the host controller in the predefined serial respond format via the serial interface. There are mainly three types of ZIGBEE devices in a network. Each device is assigned with a unique address called network address or short address upon joining the network. The network address is not permanent and will be reassigned when the device rejoins, resets, or when there are address conflict.

As the ZIGBEE module is a slave device, it responses to the host controller only when requested. If the host controller needs to keep track of the latest network address, it has poll the ZIGBEE module for it periodically. The communication overhead also increases between the host controller and the ZIGBEE module.

Therefore, there is a demand for a ZIGBEE network system that can easily report IP addresses to the mobile communication terminals receiving the IP service which can overcome the above-mentioned problems.

### BRIEF DESCRIPTION OF THE DRAWINGS

Many aspects of the embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a diagram illustrating a schematic structure of a wireless apparatus in a ZIGBEE network system according to an embodiment of the present disclosure;

FIG. 2 is a flowchart illustrating a method for storing a new address signal to a host controller in a ZIGBEE network system according to an embodiment of the present disclosure; and

FIG. 3 is a flowchart illustrating a method for assigning a new address signal in a ZIGBEE network system according to an embodiment of the present disclosure.

### DETAILED DESCRIPTION OF THE EMBODIMENT

Reference will now be made to describe the exemplary embodiments of the present disclosure in detail.

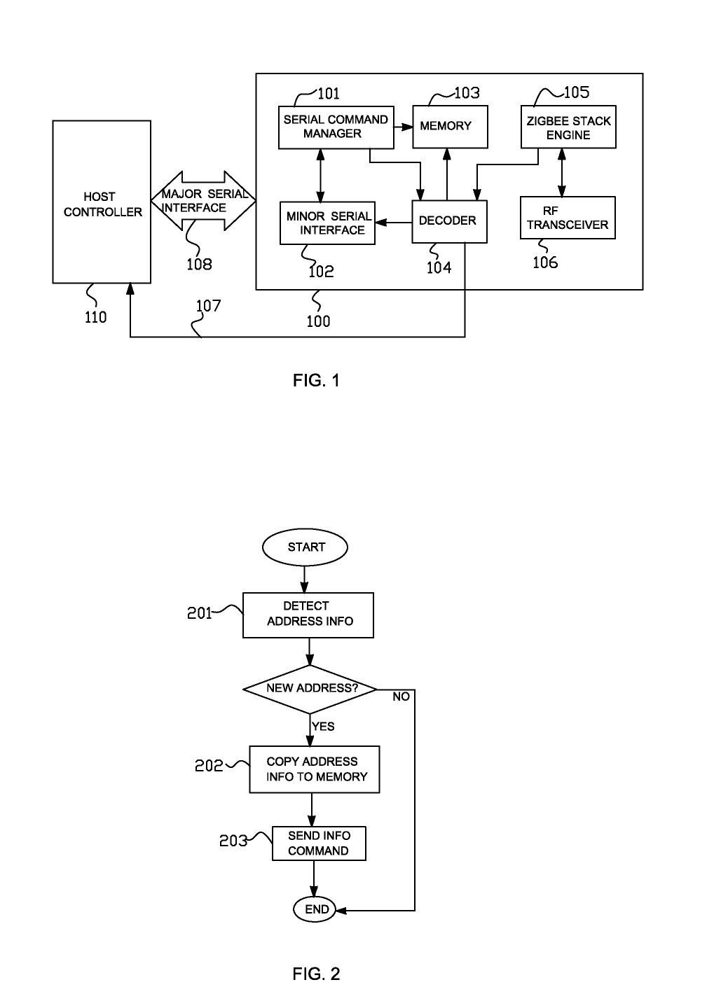

Referring to FIGS. 1 through 3, therein is illustrated an embodiment of the present disclosure, serving as a client in a ZIGBEE network system including a wireless apparatus being assigned an internet protocol address for transmitting and receiving information data. The wireless apparatus includes a host controller 110 referred to as a coordinator, a ZIGBEE module 100 serving as a client communicated with the host controller 110 via a major serial interface 108 and a digital output line 107. The ZIGBEE module includes a RF transceiver 106, a ZIGBEE stack engine 105, a decoder 104, a memory 103, a minor serial interface 102, and a serial command manger 101.

The host controller 110 controls the ZIGBEE module 100 to send a join request to a client and to receive a server address list from the client. The RF transceiver 106 performs a wireless communication function of the wireless apparatus for transmitting or receiving signals from the ZIGBEE stack engine 105. The decoder 104 receivers address signal from the ZIGBEE stack engine 105. The memory 103 can consist of a program memory and a data memory. The memory 103 stores therein a variety of information necessary for controlling an operation of the ZIGBEE module 100. The memory 103 also stores a network address list and server profile information.

Specifically, the serial command manager 101 is individually connected to the minor serial interface 102, the memory 103 and the decoder 104. The minor serial interface 102 is connected to the decoder 104. The decoder 104 is connected between the ZIGBEE stack engine 105 and the memory 103, and is connected to the host controller 110 via the digital output line 107.

In generally, the RF transceiver 106 sends a demodulated data to the ZIGBEE stack engine 105 for processing, then the ZIGBEE stack engine 105 sends a address frame to the decoder 104 for decoding. The decoder 104 receives the address frame, validates if it is valid address and whether the network address is a new address. If the network address is efficacious, the decoder 104 would copy the new address into the memory 103 and meanwhile output a signal to the host controller 110 via the digital output line 107. The host controller 110 detects the signal and acknowledges that there is a new address. Subsequently, the host controller 110 sends an address request serial command to the ZIGBEE module via the major serial interface 108. Upon responding the address request serial command, the serial command manager 101 would validate and acknowledge it. The serial command manager 101 shifts the new address from the memory 103 to the minor serial interface 102 which transmits the new address to the host controller via the major serial interface 108. Now, the host controller 110 accordingly has the new address.

FIG. 2 is a flowchart illustrating a method for reporting a network address in a ZIGBEE network system according to the embodiment of the present disclosure. The address decoder 104 determines the network address is valid based on the ZIGBEE protocol. In step 201, in order to report a real and effective network address, the decoder 104 decodes and verifies the validity of the network address, and further determines whether the network address is new data. In step 202, if the network address is new data, the decoder 104 can copy the new address data to the memory 103 for storing. In step 203, the address decoder 104 decodes the new address data into an address indication signal transmitted to the host controller 110 via the digital output line 107. Therefore, the host controller 110 knows that the ZIGBEE module 100 has a new network address.

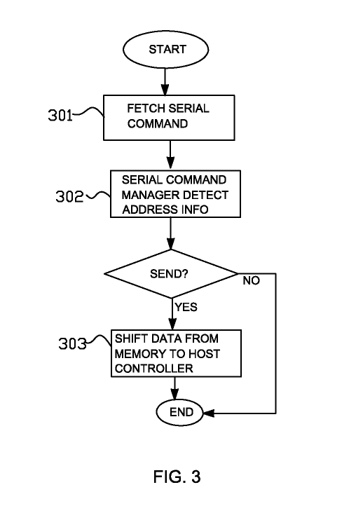

Referring to FIG. 3, in step 301, the serial manager 101 fetches a serial command from the host controller 110 via the minor serial interface 102. In step 302, the serial command manager 101 determines whether reporting the address information of the ZIGBEE module 100 to the host controller 110. Specifically, if the serial command includes an address request message of reporting the address information of the ZIGBEE module 100 to the host controller 110, and the serial command manager 101 will respond to the command. Therefore, in step 303, the serial command manager 101 indicates the memory 103 send the network address of the ZIGBEE module 100 to the minor serial interface 102. The serial command manager 101 may indicates the decoder 104 clear out the information in the digital output line 107, in step 304. Furthermore, the minor serial interface 102 reports the network address of the ZIGBEE module 100 to the host controller via the major serial interface 108.

In the present disclosure, while the address of the ZIGBEE module 100 is changed, the digital output line 107 sent a indicate signal to the host controller 110. The host controller 110 sends a command that the ZIGBEE module 100 reports the self-address data to the host controller 110 so as to the host controller 110 can be received the latest address data in time.

While the present invention has been described with reference to a specific embodiment, the description of the invention is illustrative and is not to be construed as limiting the invention. Various of modifications to the present invention can be made to the exemplary embodiment by those skilled in the art without departing from the true spirit and scope of the invention as defined by the appended claims.

What is claimed is:

1. A wireless apparatus in ZIGBEE network, comprising:
a host controller for controlling the wireless apparatus to send a join request and to receive a network address command;
a ZIGBEE module communicated with the host controller and including a RF transceiver for receiving or transmitting a signal, a ZIGBEE stack engine connected the RF transceiver, a decoder connected the ZIGBEE stack engine, a memory, a minor serial interface, and a serial command manger;
the decoder decoding an address signal from the ZIGBEE stack engine and storing the address signal to the memory, and transmitting a signal to the host controller;
the host controller sending an address request serial command according to the signal to the ZIGBEE module;
responding to the address request serial command, the serial command manager shifting the address signal from the memory to the minor serial interface and transmitting the address signal to the host controller.

2. The wireless apparatus in ZIGBEE network as claimed in claim 1 further including a digital output line connected the host controller with the decoder.

3. A method for reporting a network address in ZIGBEE network comprising the step of:
decoding an address signal from a ZIGBEE stack engine and determining the validity of the address signal;
storing the address signal to a memory according to a result of the determination; and
if the address signal is new, generating a signal to a host controller via a digital output line for reporting the host controller that the ZIGBEE stack engine has the new address signal.

4. A network address reporting method, comprising the steps of:
providing a host controller;
providing a wireless communication module wirelessly communicated with the host controller;
the wireless communication module sending a new address signal to the host controller when the network address changes;
the host controller distributing a new address reporting command to the wireless communication module after receiving the new address signal from the wireless communication module.

5. The network address reporting method as described in claim 4, wherein the wireless communication module is a ZIGBEE module.

6. The network address reporting method as described in claim 5 further comprising the steps of:
providing a ZIGBEE stack engine and an address memory;
the ZIGBEE stack engine copy the new address and send the new address to the memory.
